(19) United States
(12) Patent Application Publication
(10) Pub. No.: US 2006/0085107 A1
(43) Pub. Date: Apr. 20, 2006

(54) Tram with gravity driven vehicles and method for controlling the operation of the tram

(75) Inventors: Otto Hoffmann, Uhingen (DE); Horst Seifert, Aichwald (DE)

Correspondence Address: LERNER GREENBERG STEMER LLP, P O BOX 2480, HOLLYWOOD, FL, 33022-2480, US

(73) Assignee: Innova Patent GmbH

(21) Appl. No.: 11/088,430

(22) Filed: Mar. 24, 2005

(30) Foreign Application Priority Data
Mar. 24, 2004 (AT) A 521/2004

(51) Int. Cl. G01C 22/00

(52) U.S. Cl. 701/23; 180/168

(57) ABSTRACT

A railroad, in particular an amusement ride, has a route subdivided into sections. Vehicles driven exclusively by gravity move along the route. Switching elements are arranged on the route for switches situated on the vehicles, in order to determine the position of the vehicles on the route. Vehicle controllers on the vehicles are connected to a central controller via a radio network. Brakes are arranged on the vehicles. Therefore, apart from the switching elements, all safety-relevant parts are shifted from the railroad to the vehicles and the vehicles are equipped with controllers, so that they can brake automatically and at any time if necessary, e.g. in the event of a failure or a disruption of the communication with the central controller.

### BACKGROUND OF THE INVENTION

Field of the Invention

The invention relates to a tram, in particular an amusement ride such as an entertainment railroad or aerial cableway, having a route subdivided into sections, having vehicles that move along the route in a manner driven exclusively by gravity at least in sections, having a central controller and having switching elements for switches in order to determine the position of the vehicles on the route. The switches are connected to the central controller.

The invention furthermore relates to a method for controlling the movement of at least one vehicle along a route subdivided into sections, in particular of an entertainment device, in which the vehicles are driven exclusively by gravity at least in sections, in which that section of the route in which the vehicle is currently situated is detected by means of at least one switching element and at least one switch, and in which a corresponding item of information is transmitted to a central controller.

Such entertainment trams and methods for controlling the operation and in particular for monitoring safety functions and for possible deceleration of the vehicles are known in the prior art. In this case, switches or sensors are disposed on the railroad and report a signal to the central controller when the vehicle travels past. As a result, the central controller can detect which section of the railroad is occupied by a vehicle and which section is free. The sensors or switches are fixedly connected by cabling to the central controller and switching elements that actuate the switches are situated on the vehicles. The switches have to be connected by cabling by means of decentralized peripherals with or in terminal boxes, which necessitates a heating system if the railroad is to be operated even at temperatures of around or below 0° C. There is also the risk of dewing, which has to be prevented by special measures. On account of the long cabling, the data transmission rate from the switches to the central controller decreases to a very great extent with length, as a result of which long reaction times arise.

In the case of a hazard or impending danger, for example when two vehicles get too close to one another, the vehicles can only be stopped by actuating safety brakes on the railroad. If a section change has taken place, and the succeeding section is not free, the central controller can therefore only stop the vehicle by activating the safety brakes on the route. The central controller furthermore ensures, by means of corresponding start sequence times, that the vehicles on the route are at a sufficiently great distance and cannot catch up to one another.

Since many safety-relevant parts are situated on the route (cabling, switches, brakes, etc.), there is also a not inconsiderable risk of intentional or inadvertent damage, which increases the risk of an accident.

### SUMMARY OF THE INVENTION

It is accordingly an object of the invention to provide a tram, in particular an entertainment railroad or aerial cableway, which overcomes the above-mentioned disadvantages of the heretofore-known devices and methods of this general type and which is further improved in terms of the safety and controllability of the vehicles that move along the railroad.

With the foregoing and other objects in view there is provided, in accordance with the invention, a tram, in particular such a device suited for an amusement ride, comprising:

a route divided into a plurality of route sections;

a central controller;

a plurality of vehicles configured to travel along the route substantially exclusively driven by gravity, at least in sections of the route, and having vehicle controllers connected to the central controller through wireless connection;

switching elements disposed along the route and respectively assigned to the route sections;

switches respectively mounted to the vehicles and connected to the vehicle controllers, the switches cooperating with the switching elements for determining a position of the vehicles along the route.

With the above and other objects in view there is also provided, in accordance with the invention, a method of controlling a movement of at least one vehicle along a route divided into sections. The novel method comprises the following steps:

driving the at least one vehicle substantially exclusively by gravity, at least in sections, along the route;

detecting a section of the route in which the vehicle is currently located by way of at least one switching element and at least one switch connected to a vehicle controller mounted to the vehicle;

transmitting a corresponding item of information from the vehicle controller to a central controller by wireless communication and determining a current location of the vehicle with the central controller.

In the novel system, apart from the switching elements, all safety-relevant parts are shifted from the railroad to the vehicles, and the vehicles are equipped with controllers, so that they can carry out emergency braking automatically and at any time if necessary, e.g. in the event of a failure or a disruption of the communication with the central controller. Furthermore, the vehicles are able to regulate the distance from a vehicle traveling ahead of them by means of targeted braking, since the controller of each vehicle, by means of the central controller, knows the position preferably of every other but at the very least the position of the vehicle traveling directly ahead of it, i.e. the section in which the vehicle is situated or the vehicles are situated.

The switching elements on the route may be embodied in such a way that they manage without any power supply or communication with the central controller, with the result that cabling on the route is entirely obviated. The vehicle controllers in turn may be connected to the central controller via a safety-oriented, radio-controlled bus system, thereby affording very high safety (safety category 4 according to EN954 or according to IEC/EN 61508).

The controller furthermore has double safety since the position of each vehicle in the individual sections is monitored both by the central controller and by the vehicle controller, and the vehicle controllers are continuously in contact with the central controller via a permanent, bidirectional radio link. Therefore, if the radio link is interrupted or disrupted or the data communicated by the central controller do not logically correspond to the data stored in the vehicle controller, each vehicle can be immediately halted independently of all the other vehicles. It is also possible to halt the vehicles only in specific sections of the route. Moreover, the vehicles independently of the central controller, may carry out safety checks (signal tests, functional tests or tests of the safety brake and of the trimming brake) in defined sections of the route (e.g. in the railroad station) and report the result to the central controller.

In accordance with an added feature of the invention, the vehicles are not equipped with individual drives.

In accordance with an additional feature of the invention, the switching elements are configured to actuate the switches by contactless actuation.

In accordance with another feature of the invention, the switching elements are respectively disposed at transitions from one of the route sections to a following the route section.

In accordance with a further feature of the invention, each switching element has two or more transmitters having assigned sensors on the switches of the vehicles. Preferably, the switching elements have at least one transmitter for signifying a section change and at least one transmitter for identifying the switching element. In a further variation, the switching elements have two groups of transmitters as seen in a direction of travel.

In accordance with again an added feature of the invention, the switching elements comprise magnetically conductive material identifiable by the sensors.

In accordance with again an additional feature of the invention, the switching elements have permanent magnets.

In accordance with a further development of the invention, there are trimming brakes mounted to each vehicle. Similarly, each vehicle may be equipped with a safety brake.

In accordance with a concomitant feature of the invention, the wireless connection between the vehicle controllers and the central controller is formed as a safety-oriented data transmission system, in particular a bus system.

Other features which are considered as characteristic for the invention are set forth in the appended claims.

Although the invention is illustrated and described herein as embodied in a tram with gravity driven vehicles and method for controlling the operation of the tram, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic view of a tram according to the invention;

FIG. 2 is a schematic view of the connection of the central controller to the vehicle controllers;

FIG. 3 is a schematic view illustrating the assignment of the switching elements and of the switches;

FIG. 4 is a schematic view of exemplary embodiments of the assignment of the switching elements and of the switches;

FIG. 5 is a schematic view of a further possibility for assignment of the switching elements and of the switches;

FIG. 6 is a schematic view of exemplary embodiments of the assignment of the switching elements and of the switches in accordance with FIG. 5;

FIG. 7 is a partial top, side perspective of an exemplary arrangement of the switching elements and of the switches on the route and on the vehicle;

FIG. 8 is an enlarged detail from FIG. 7; and

FIG. 9 is a section through the configuration of FIGS. 7 and 8.

### DESCRIPTION OF THE PREFERRED EMBODIMENTS

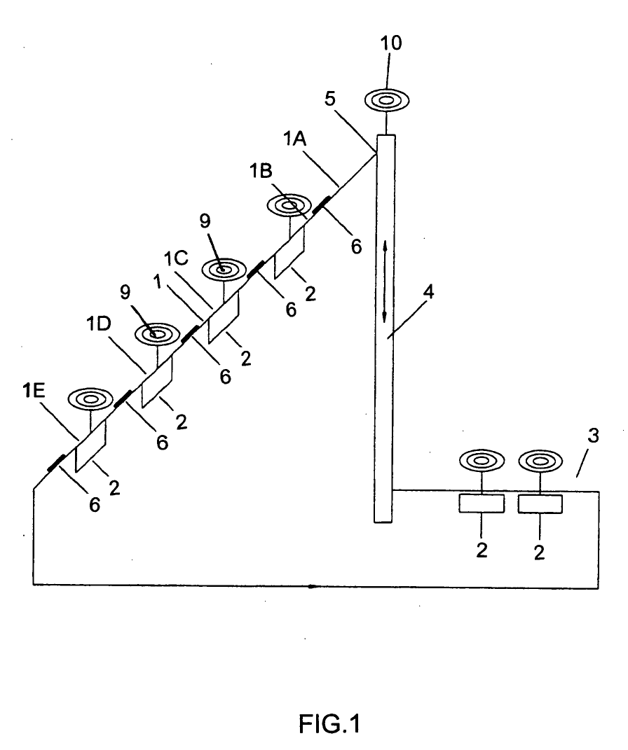

Referring now to the figures of the drawing in detail and first, particularly, to FIG. 1 thereof, there is shown a schematic illustration of a tram in the form of an amusement ride. The latter comprises a route 1 divided into sections 1a, 1b, 1c, 1d and 1e. The route itself may be for example a rail system or some other traveling profile on which vehicles 2 slide or roll in upright or suspended fashion. The vehicles themselves do not require their own drive. The route 1 may furthermore be straight or curved, and have not only a declivity, but also acclivities, but declivities and acclivities succeed one another in such a way that the vehicles can always progress without a drive motor, i.e. only through gravity. In principle, however, it is also conceivable for the route to be subdivided into route portions between which the vehicles are driven back up to a higher level by way of external, stationary drive means.

The route 1 for the vehicles 2 then leads to a railroad station 3, from where the vehicles are conveyed back to a start 5 by means of a lifting apparatus 4.

As already mentioned, the route 1 is divided into individual sections 1a to 1e, switching elements 6 being disposed at the transitions between the individual sections. The switching elements 6 are assigned switches with sensors 21 to 26 on the vehicles 2. Therefore, if a vehicle 2 moves past a switching element 6, the switch identifies a section change and reports this to a central controller 8 by way of a vehicle controller 7 that is disposed on board, via a bidirectional, safety-oriented radio link. The vehicles 2 therefore have transmitting/receiving antennas 9, and the central controller likewise has a transmitting/receiving antenna 10.

Finally, the vehicles also have a trimming brake and a safety brake. The trimming brake serves for regulating the traveling speed of the vehicles, whereas the safety brake is intended and designed for an emergency stop of the vehicles.

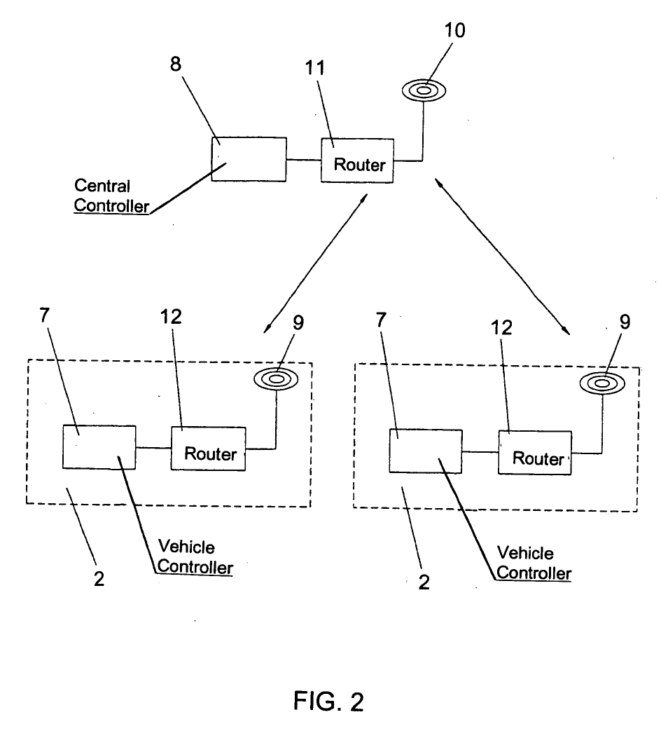

In the exemplary embodiment illustrated, the radio link is a bidirectional, safety-oriented BUS system with radio routers 11 and 12 as shown in FIG. 2. Both the central controller 8 and the vehicle controllers 7 are so-called safety stored-program controllers, which ensure a correspondingly high safety level of the operation of the railroad. Via the radio router 11 and the transmitting/receiving antenna 10, the central controller 8 is continuously in contact with the vehicle controllers 7 that are likewise provided with radio routers 12 and transmitting/receiving antennas 9. By virtue of this permanent radio link, the central controller 8 always knows the current position of each vehicle 2 and the safety status thereof. Equally, each vehicle 2 or the controller 7 thereof always knows the position or the section in which every other vehicle 2 is situated and can thus automatically determine the distance from the preceding vehicle 2 with the aid of the trimming brake in such a way that a safety-critical approach does not occur.

According to the invention, the switching element uses is a group of transmitters, which not only reveal a section change of a vehicle but at the same time also supply a specific item of information regarding which section change is currently being crossed. This affords additional safety since the vehicle controller 7 has a monitoring possibility for identifying an incorrect or absent item of section change information.

By way of the transmitters, which signal only one section change each, the vehicle controller can determine which identifier (e.g. number) a section change must have. The controller can compare this with the information supplied by the transmitters for the section number. If a discrepancy occurs here, either the switching elements or transmitters on the route are defective or the corresponding sensors on the vehicle or the vehicle controller itself has a defect, and it is possible to carry out corresponding countermeasures such as, for example, an emergency stop of the affected vehicle and of the succeeding vehicles and also a monitoring of the switching elements and switches or of the vehicle controller.

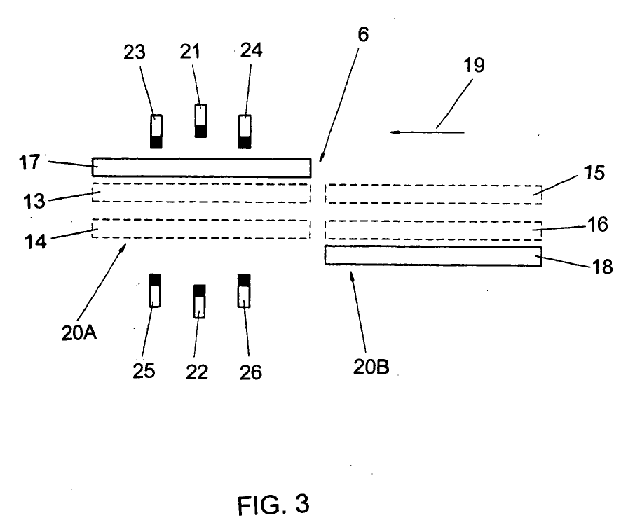

The exemplary embodiment illustrated in FIG. 3 schematically illustrates a switching element 6 having four possible positions 13, 14, 15 and 16 for transmitters, the occupation of which enables a precise identification of the switching element. The further positions 17 and 18 on the switching element 6 are intended for transmitters which on the one hand only supply the information that a switching element is being crossed (thus an item of information that a section change is currently taking place), but on the other hand perform a so-called “trigger function” in order to enable an exact check of the occupation of the transmitter positions 13 to 16.

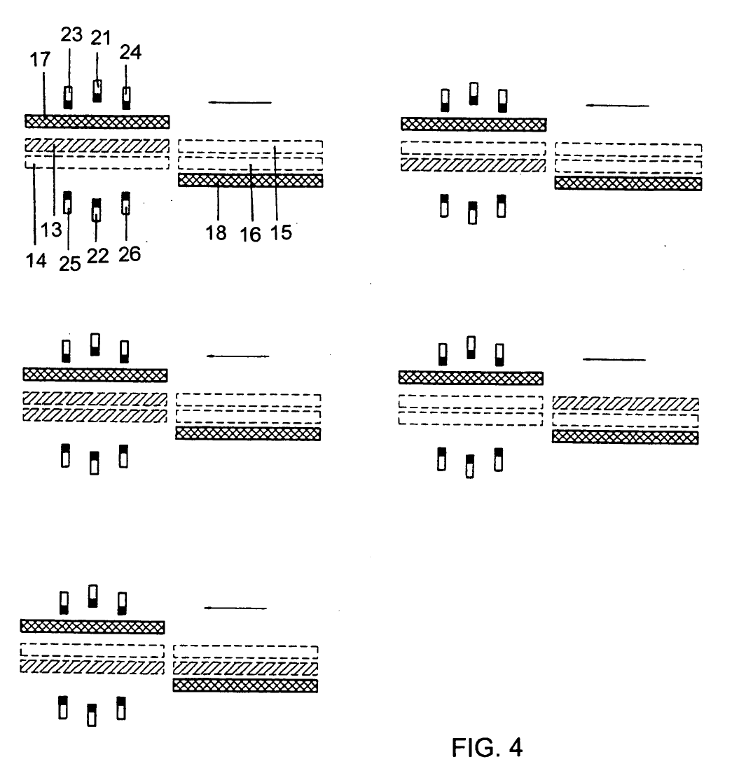

It is evident in FIG. 3 that a switching element 6 is subdivided into two groups 20a, 20b of transmitters, namely the transmitters 13, 14 and 17 in group 20a and the transmitters 15, 16 and 18 in group 20b, as seen in the direction of travel (arrow 19). On the route 1 itself, the positions 17 and 18 of the transmitters for a section change are always occupied, as shown by the examples in FIG. 4. In the illustration in FIG. 4, positions occupied by transmitters are illustrated in hatched fashion, whereas positions that are not occupied by transmitters are shown blank and only with a dashed border.

Sensors 21 and 22 assigned to the transmitters in position 13 and 15 and, respectively, 14 and 16 are situated on the vehicle. Furthermore, sensors 23, 24 and 25, 26 assigned to the positions 17 and 18 of the transmitters are fitted to the vehicle.

If a vehicle moves past the switching element 6 in arrow direction 19, then firstly the sensors 25 and 26 are activated by the transmitter 18 as soon as they are situated fully beside the latter. This is the triggering signal for the controller to ascertain on the basis of the sensors 21 and 22 whether the positions 15 and 16 are occupied by transmitters. Afterward, if the vehicle has moved on, the sensors 23 and 24 are activated by the transmitter 17, which is in turn the signal for the controller to ascertain with the aid of the sensors 21 and 22 whether the positions 13 and 14 are occupied by transmitters.

FIG. 4 illustrates various examples of how the positions 13 to 16 may be occupied by transmitters, four positions resulting in a total of sixteen possibilities for occupying them differently. On the sections 1a to 1e of the route, the positions 17 and 18, as already mentioned, are always occupied by transmitters since they are the triggers for the sensors 21 and 22 to ascertain the occupation of the positions 13 to 16.

This type of arrangement or occupation of positions for the transmitters affords very high safety since “read errors” cannot occur if the vehicles move past the switching elements 6 at relatively high speed.

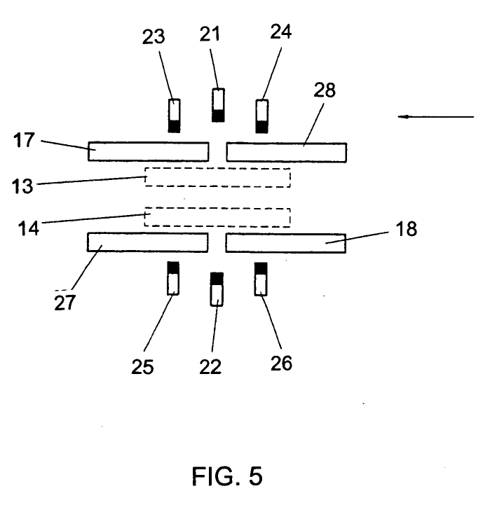

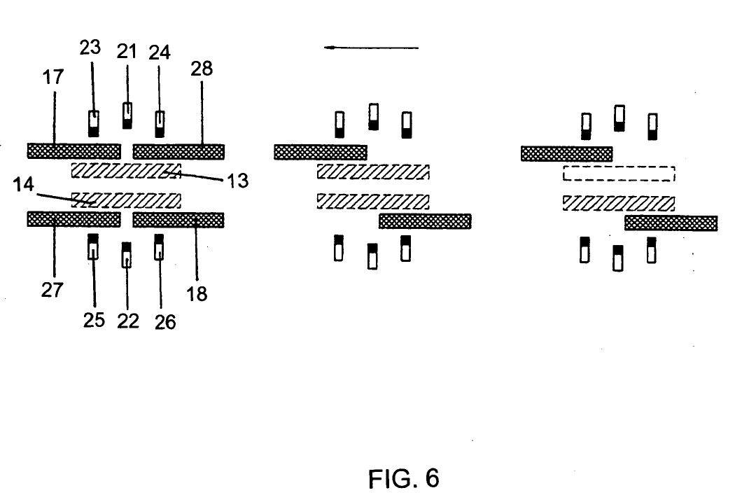

The situation is different in the railroad station 3 or on regions of the route on which the vehicles are moved only at relatively low speed. There it is possible to employ a positioning or occupation such as is illustrated schematically in FIG. 5. The sensors 21 to 26 on the vehicle are unchanged in this case. What has changed, by contrast, is that there are two additional positions 27 and 28 besides the two positions or transmitters 17 and 18, whereas only two positions 13 and 14 for transmitters are provided for the determination of what control element is explicitly involved. This results in further possibilities for determining the position for the vehicles 2, as is illustrated by way of example in FIG. 6.

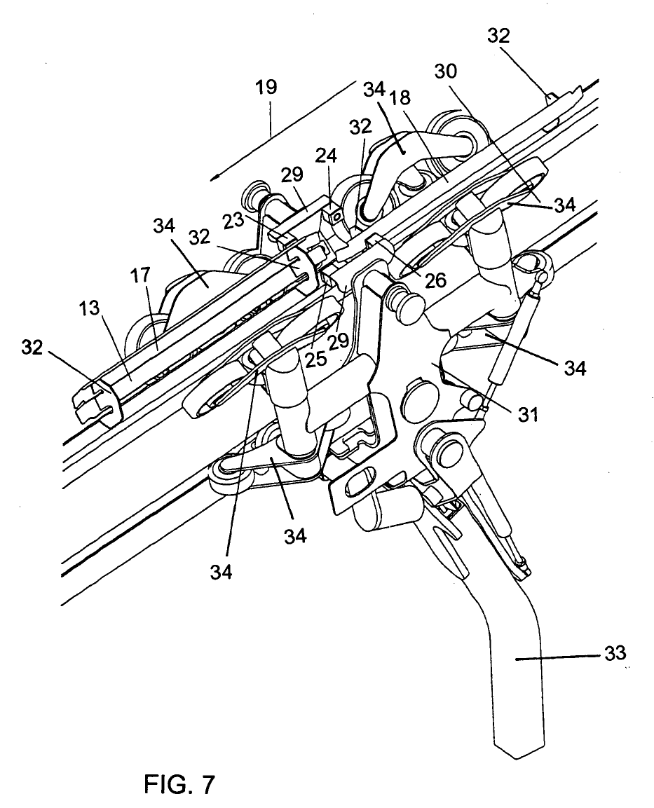

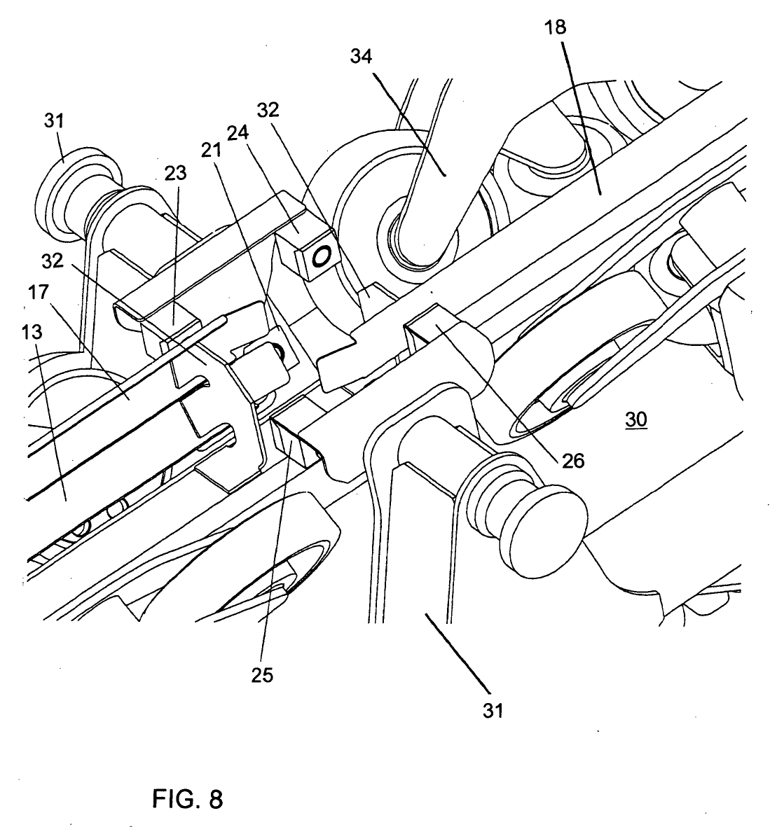

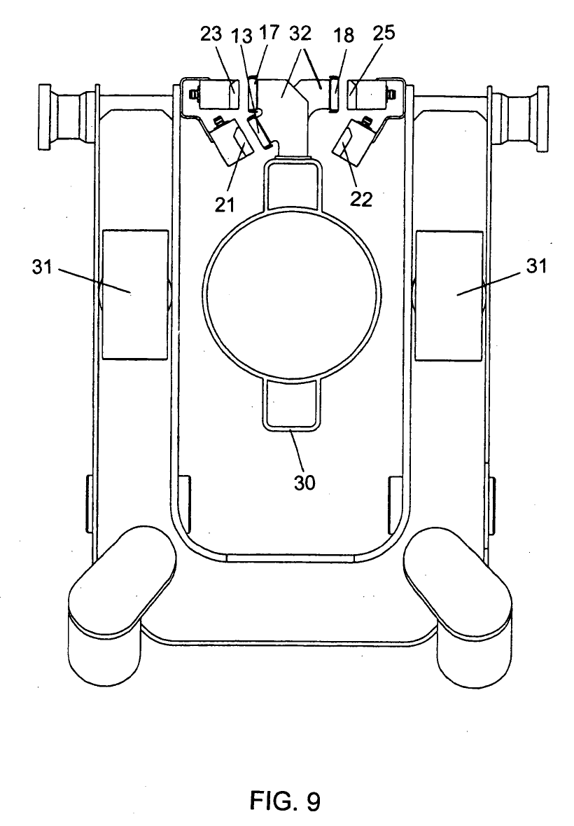

FIGS. 7, 8 and 9 illustrate a traveling profile 30 of the route 1, along which a vehicle travels in suspended fashion. The vehicle itself is not illustrated, rather only a running gear 31 of a vehicle 2 to which the sensors 21 to 26 of the switches 29 are fixed. The non-illustrated passenger carrier (chair, cabin or the like) is suspended from the running gear 31 on a rod 33. The running gear rolls on the traveling profile 30 over eight pairs of wheels 34 suspended in rocking fashion. The pairs of wheels 34 are not illustrated in FIG. 9 for reasons of better or clearer illustration of the switches 29.

The disposition of transmitters corresponds to the top left exemplary embodiment in FIG. 4, that is to say that only the position 13, but not the positions 14, 15 and 16, is occupied by a transmitter for the section transition number. Transmitters can furthermore be seen at the positions 17 and 18 in FIGS. 7 to 9. The transmitters 13, 17 and 18 are fixed to the traveling profile 30 on mounting brackets 32.

The sensors 21 to 26 that detect the presence of transmitters are fixed to the running gear 31.

In the exemplary embodiment, the transmitters 13, 17 and 18 as well as transmitters present if need be at other positions are iron rails which are magnetized by initiators, assigned to the sensors 21 to 26, upon traveling past, so that the presence of the transmitters can be detected by the sensors.

Instead of the soft-magnetic transmitters, other forms of switching elements could also be used, e.g. those of permanent-magnetic type or those having a light-reflecting surface, in which case the initiators and sensors on the vehicle have to be adapted correspondingly, of course.

This application claims the priority, under 35 U.S.C. § 119, of Austrian patent application No. A 521/2004, filed Mar. 24, 2004; the entire disclosure of the prior application is herewith incorporated by reference.

We claim:

1. A tram, comprising:
a route divided into a plurality of route sections;
a central controller;
a plurality of vehicles configured to travel along said route substantially exclusively driven by gravity, at least in sections of said route, and having vehicle controllers connected to said central controller through wireless connection;
switching elements disposed along said route and respectively assigned to said route sections;
switches respectively mounted to said vehicles and connected to said vehicle controllers, said switches cooperating with said switching elements for determining a position of said vehicles along said route.

2. The tram according to claim 1, wherein said vehicles do not have individual drives.

3. The tram according to claim 1, wherein said switching elements are configured to actuate said switches by contactless actuation.

4. The tram according to claim 1, wherein said switching elements are respectively disposed at transitions from one of said route sections to a following said route section.

5. The tram according to claim 1, wherein each said switching element has two or more transmitters having assigned sensors on said switches of said vehicles.

6. The tram according to claim 5, wherein said switching elements have at least one transmitter for signifying a section change and at least one transmitter for identifying said switching element.

7. The tram according to claim 5, wherein said switching elements have two groups of transmitters as seen in a direction of travel.

8. The tram according to claim 4, wherein said switching elements have two groups of transmitters as seen in a direction of travel.

9. The tram according to claim 5, wherein said switching elements comprise magnetically conductive material identifiable by said sensors.

10. The tram according to claim 7, wherein said transmitters comprise magnetically conductive material identifiable by said sensors.

11. The tram according to claim 1, wherein said switching elements have permanent magnets.

12. The tram according to claim 1, which comprises a trimming brake mounted to each vehicle.

13. The tram according to claim 1, which comprises a safety brake mounted to each vehicle.

14. The tram according to claim 1, wherein said wireless connection between said vehicle controllers and said central controller includes a safety-oriented data transmission system.

15. The tram according to claim 1, wherein said wireless connection between said vehicle controllers and said central controller is formed with a bus system.

16. A method of controlling a movement of at least one vehicle along a route divided into sections, the method which comprises:
driving the at least one vehicle substantially exclusively by gravity, at least in sections, along the route;
detecting a section of the route in which the vehicle is currently located by way of at least one switching element and at least one switch connected to a vehicle controller mounted to the vehicle;
transmitting a corresponding item of information from the vehicle controller to a central controller by wireless communication and determining a current location of the vehicle with the central controller.

17. The method according to claim 16, which comprises detecting with the switch that the vehicle is moving past the switching element.

18. The method according to claim 16, which comprises uniquely identifying the respective switching element with the switch.

19. The method according to claim 16, which comprises, with at least one of the vehicle controller and the central controller, comparing a number of switching elements past which a vehicle moves and an identification of a switching element.

20. The method according to claim 16, which comprises comparing, with the vehicle controller in a following vehicle, a position of a leading vehicle with the position of the following vehicle, and braking the following vehicle if required.

21. The method according to claim 16, which comprises, with the central controller, comparing a position of a leading vehicle with a position of a directly succeeding vehicle, and transmitting a braking command to the succeeding vehicle as required.

22. The method according to claim 16, which comprises continually comparing position data in the vehicle controller with position data of the respective vehicle in the central controller, and automatically initiating emergency measures in an event of safety-relevant deviations.

23. The method according to claim 16, which comprises effecting the wireless connection between the vehicle controllers and the central controller with a safety-oriented data transmission system.

24. The method according to claim 16, which comprises effecting the wireless connection between the vehicle controllers and the central controller with a safety-oriented bus system.

25. The method according to claim 16, which comprises driving the vehicles exclusively with stationary drives.

26. In an amusement ride with a plurality of vehicles, the method according to claim 16.
